(19) United States
(12) Patent Application Publication
(10) Pub. No.: US 2022/0377143 A1
(43) Pub. Date: Nov. 24, 2022

(54) ON-DEMAND LIVENESS UPDATES BY SERVERS SHARING A FILE SYSTEM

(71) Applicant: VMWARE, INC., Palo Alto, CA (US)

(72) Inventors: SIDDHANT GUPTA, Bangalore (IN); SRINIVASA SHANTHARAM, Bangalore (IN); ZUBRAJ SINGHA, Bangalore (IN)

(21) Appl. No.: 17/372,643

(22) Filed: Jul. 12, 2021

(30) Foreign Application Priority Data
May 21, 2021 (IN) 202141022859

(51) Int. Cl. H04L 29/08; G06F 16/182

(52) U.S. Cl. CPC H04L 67/14; G06F 16/182

(57) ABSTRACT

A method of managing liveness information of a first server of a plurality of servers sharing a file system includes: periodically reading an alarm bit of the first server from a region in the file system allocated for storing liveness information of the first server; after each read, determining a value of the alarm bit; and upon determining that the value of the alarm is a first value, changing the alarm bit to a second value, and writing the alarm bit having the second value in the region. The second value indicates to other servers of the plurality of servers that the first server is alive.

### RELATED APPLICATIONS

Benefit is claimed under 35 U.S.C. 119(a)-(d) to Foreign Application Serial No. 202141022859 filed in India entitled “ON-DEMAND LIVENESS UPDATES BY SERVERS SHARING A FILE SYSTEM”, on May 21, 2021, by VMware, Inc., which is herein incorporated in its entirety by reference for all purposes.

### BACKGROUND

A file system for a high-performance cluster of servers may be shared among the servers to provide a shared storage system for virtual machines (VMs) that run on the servers. One example of such a file system is a virtual machine file system (VMFS), which stores virtual machine disks (VMDKs) for the VMs as files in the VMFS. A VMDK appears to a VM as a disk that conforms to the SCSI protocol.

Each server in the cluster of servers uses the VMFS to store the VMDK files, and the VMFS provides distributed lock management that arbitrates access to those files, allowing the servers to share the files. When a VM is operating, the VMFS maintains an on-disk lock on those files so that the other servers cannot update them.

The VMFS also uses an on-disk heartbeat mechanism to indicate the liveness of servers (also referred to as hosts). Each server allocates an HB (Heartbeat) slot on disk when a volume of the VMFS is opened and is responsible for updating a timestamp in this slot every few seconds. The timestamp is updated using an Atomic-Test-Set (ATS) operation. In one embodiment, the ATS operation has as its input a device address, a test buffer and a set buffer. The storage system atomically reads data from the device address and compares the read data with the test buffer. If the data matches, the set buffer is written to the HB slot on disk. If the atomic write is not successful, the server retries the ATS operation. If the server gets an error from the storage system, then it reverts to SCSI-2 Reserve and Release operation on the entire disk to update the timestamp.

The ATS operation is time-consuming, and resorting to the SCSI-2 Reserve and Release incurs an even greater impact on performance, especially for a large disk, as it locks the entire disk and serializes many of the I/Os to the disk. When a larger number of servers are part of the cluster and share the file system, this problem is expected to introduce unacceptable latencies.

### BRIEF DESCRIPTION OF THE DRAWINGS

FIG. 1A depicts a block diagram of a computer system that is representative of a virtualized computer architecture in which embodiments may be implemented.

FIG. 1B depicts a block diagram of a computer system that is representative of a non-virtualized computer architecture in which embodiments may be implemented.

FIGS. 2A and 2B each depict a cluster of hosts connected to a file system shared by the cluster.

FIG. 3 is a diagram illustrating the layout of a shared volume of the shared file system.

FIG. 4A depicts the flow of operations for host initialization carried out by a file system driver of a host.

FIG. 4B depicts the flow of operations for a host to close its access to a logical unit provisioned in the shared file system.

FIG. 5 depicts the flow of operations that are carried out by a file system driver of a host to update its liveness information as needed.

FIG. 6 depicts the flow of operations that are carried out by a file system driver of a host to acquire a lock on a file stored in a shared file system.

FIG. 7 depicts the flow of operations for a liveness check carried out on an owner host by a file system driver of a contending host.

FIG. 8 depicts the flow of operations that are carried out by the file system driver of the contending host to determine whether the owner host is alive or not alive.

### DETAILED DESCRIPTION

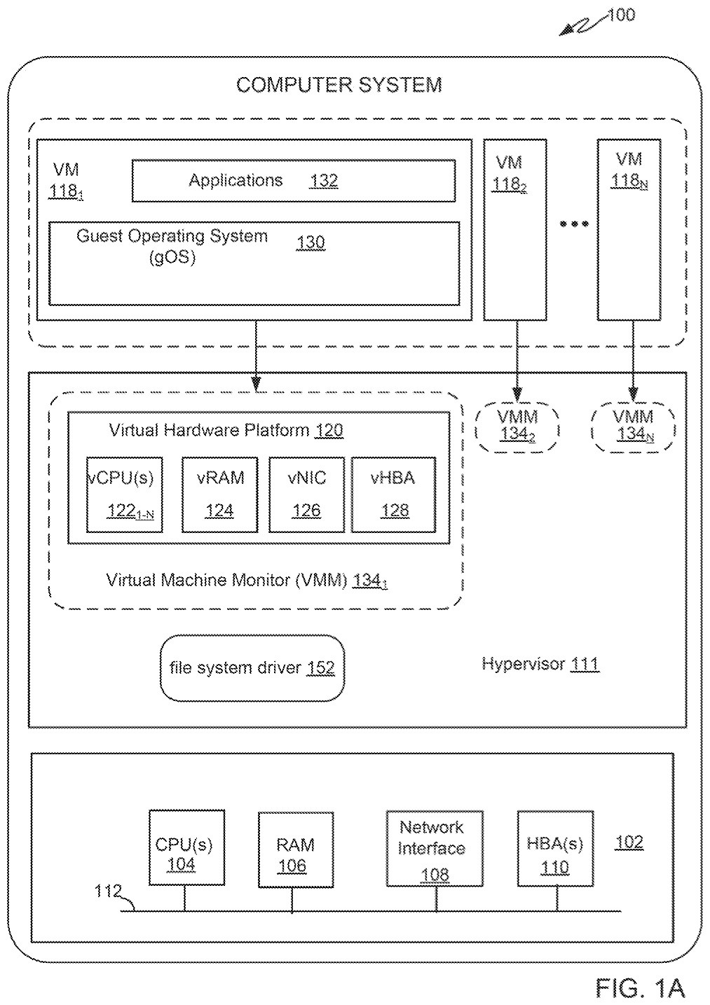

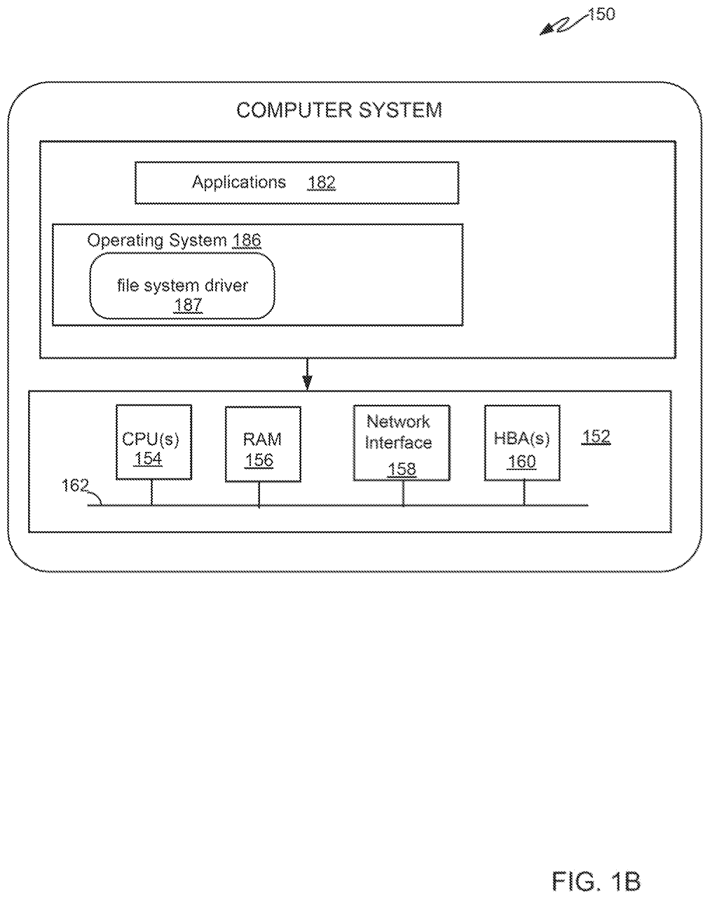

FIG. 1A depicts a block diagram of a computer system 100 that is representative of a virtualized computer architecture in which embodiments may be implemented. As is illustrated, computer system 100 hosts multiple virtual machines (VMs) 118₁-118_{N} that run on and share a common hardware platform 102. Hardware platform 102 includes conventional computer hardware components, such as one or more items of processing hardware such as central processing units (CPUs) 104, a random access memory (RAM) 106, one or more network interfaces 108 for connecting to a network, and one or more host bus adapters (HBA) 110 for connecting to a storage system, all interconnected by a bus 112.

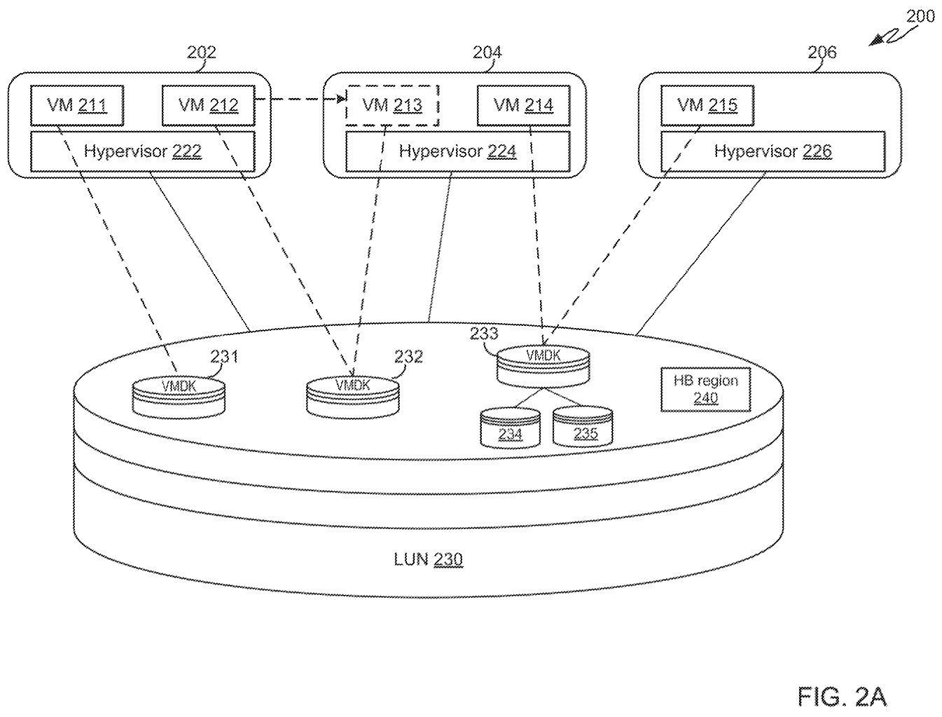

A virtualization software layer, referred to hereinafter as hypervisor 111, is installed on top of hardware platform 102. Hypervisor 111 makes possible the concurrent instantiation and execution of one or more virtual machines (VMs) 118₁-118_{N}. The interaction of a VM 118 with hypervisor 111 is facilitated by the virtual machine monitors (VMMs) 134. Each VMM 134₁-134_{N} is assigned to and monitors a corresponding VM 118₁-118_{N}. In one embodiment, hypervisor 111 may be a hypervisor implemented as a commercial product in VMware's vSphere® virtualization product, available from VMware Inc. of Palo Alto, Calif. In an alternative embodiment, hypervisor 111 runs on top of a host operating system which itself runs on hardware platform 102. In such an embodiment, hypervisor 111 operates above an abstraction level provided by the host operating system. As illustrated, hypervisor 111 includes a file system driver 152, which maintains a heartbeat on a shared volume shown in FIG. 2A to indicate that it is alive to other computer systems in a cluster that includes computer system 100.

After instantiation, each VM 118₁-118_{N} encapsulates a virtual hardware platform that is executed under the control of hypervisor 111, in particular the corresponding VMM 122₁-122_{N}. For example, virtual hardware devices of VM 118₁ in virtual hardware platform 120 include one or more virtual CPUs (vCPUs) 122₁-122_{N}, a virtual random access memory (vRAM) 124, a virtual network interface adapter (vNIC) 126, and virtual HBA (vHBA) 128. Virtual hardware platform 120 supports the installation of a guest operating system (guest OS) 130, on top of which applications 132 are executed in VM 118₁. Examples of guest OS 130 include any of the well-known commodity operating systems, such as the Microsoft Windows® operating system, the Linux® operating system, and the like.

It should be recognized that the various terms, layers, and categorizations used to describe the components in FIG. 1A may be referred to differently without departing from their functionality or the spirit or scope of the disclosure. For example, VMMs 134₁-134_{N} may be considered separate virtualization components between VMs 118₁-118_{N} and hypervisor 111 since there exists a separate VMM for each instantiated VM. Alternatively, each VMM may be considered to be a component of its corresponding virtual machine since each VMM includes the hardware emulation components for the virtual machine.

FIG. 1B depicts a block diagram of a computer system 150 that is representative of a non-virtualized computer architecture in which embodiments may be implemented. Hardware platform 152 of computer system 150 includes conventional computer hardware components, such as one or more items of processing hardware such as central processing units (CPUs) 154, a random access memory (RAM) 156, one or more network interfaces 158 for connecting to a network, and one or more host bus adapters (HBA) 160 for connecting to a storage system, all interconnected by a bus 162. Hardware platform 152 supports the installation of an operating system 186, on top of which applications 182 are executed in computer system 150. Examples of an operating system 186 include any of the well-known commodity operating systems, such as the Microsoft Windows® operating system, the Linux® operating system, and the like. As illustrated, operating system 186 includes a file system driver 187, which maintains a heartbeat on a shared volume shown in FIG. 2B to indicate that it is alive to other computer systems in a cluster that includes computer system 150.

FIGS. 2A and 2B each depict a cluster of hosts connected to a file system shared by the cluster. In the embodiments illustrated herein, a logical unit number (LUN) is a logical volume of the shared file system that is mounted within the hypervisor or operating system running in the hosts. The LUN is backed by a portion of a shared storage device, which may be a storage area network (SAN) device, a virtual SAN device that is provisioned from local hard disk drives and/or solid-state drives of the hosts, or a network-attached storage device. FIG. 2A depicts a cluster of hosts 202, 204, 206 that share LUN 230. FIG. 2B depicts a cluster of hosts 252, 254, 256 that share LUN 280.

In FIG. 2A, each host 202, 204, 206 has a hypervisor that supports execution of VMs. Host 202 has hypervisor 222 that supports execution of one or more VMs, e.g., VMs 211, 212. Host 204 has hypervisor 224 that supports execution of one or more VMs, e.g., VMs 213, 214. VM 213 is shown in dashed lines to indicate that the VM is being migrated from host 202 to host 204. Host 206 has hypervisor 226 that supports execution of one or more VMs, e.g., VM 215. VMDKs 231-235 are virtual disks of the VMs, which are stored as files in LUN 230. As depicted in FIG. 2A, VMDK 231 is a virtual disk of VM 211. VMDK 232 is a virtual disk for both VM 212 and VM 213. VMDK 233 is a base virtual disk for both VM 214 and VM 215. VMDK 234 is a virtual disk for VM 214 that captures changes made to VMDK 234 by VM 214. VMDK 235 is a virtual disk for VM 215 that captures changes made to VMDK 234 by VM 215. LUN 230 also include a heartbeat region 240, described below.

In FIG. 2B, each host 252, 254, 256 has an operating system that supports the execution of applications. Host 252 has OS 272 that supports the execution of one or more applications 261. Host 254 has OS 274 that supports the execution of one or more applications 262. Host 256 has OS 276 that supports the execution of one or more applications 263. Files of LUN 280, depicted herein as files 281-285, are accessible by any of the applications running in hosts 252, 254, 256. LUN 280 also includes a heartbeat region 290, described below.

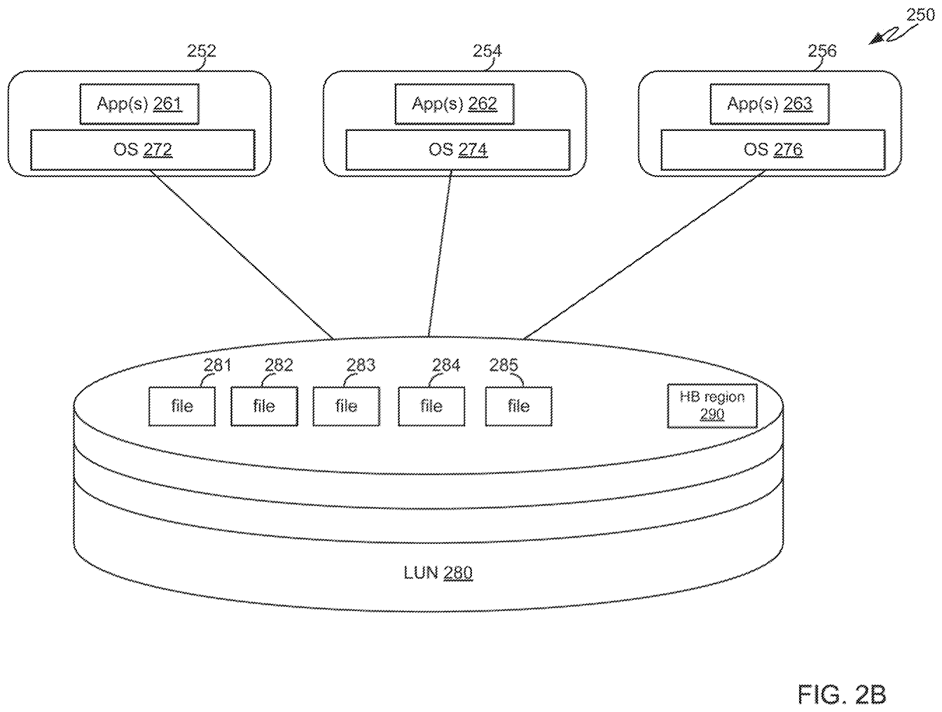

FIG. 3 is a diagram illustrating the layout of LUN 300, e.g., either LUN 230 or LUN 280. LUN 300 has a layout that includes volume metadata 312, heartbeat region 314, and data regions 316.

Heartbeat region 314 includes a plurality of heartbeat slots, 318₁-318_{N}, in which liveness information of hosts is recorded. Data regions include a plurality of files (e.g., the VMDKs depicted in FIG. 2A and the files depicted in FIG. 2B), each having a corresponding lock record 320_{1-N}, and file metadata 322_{1-N}, and file data 324_{1-N}. Each of lock records 320_{1-N} regulates access to the corresponding file metadata and file data.

A lock record (e.g., any of lock records 320_{1-N}) has a number of data fields, including the ones for logical block number (LBN) 326, owner 328 of the lock (which is identified by a universally unique ID (UUID) of a host that currently owns the lock), lock type 330, version number 332, heartbeat address 334 of the heartbeat slot allocated to the current owner of the lock, and lock mode 336. Lock mode 336 describes the state of the lock, such as unlocked, exclusive lock, read-only lock, and multi-writer lock.

The liveness information that is recorded in a heartbeat slot has data fields for the following information: data field 352 for the heartbeat state, which indicates whether or not the heartbeat slot is available, data field 354 for an alarm bit, data field 356 for an alarm version, which is incremented for every change in the alarm bit, data field 360 for identifying the owner of the heartbeat slot (e.g., host UUID), and data field 362 for a journal address (e.g., a file system address), which points to a replay journal.

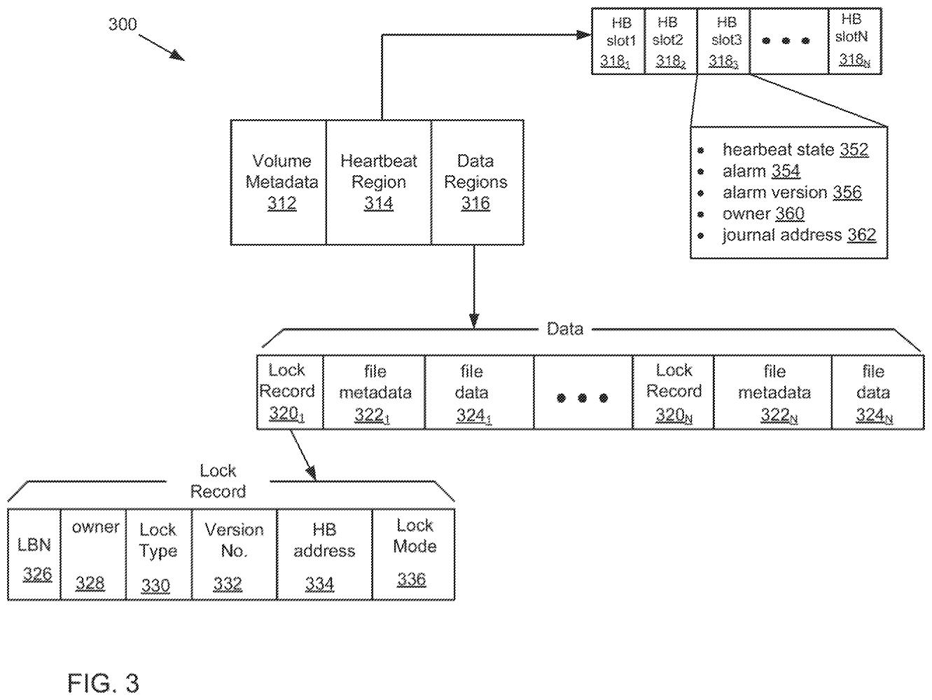

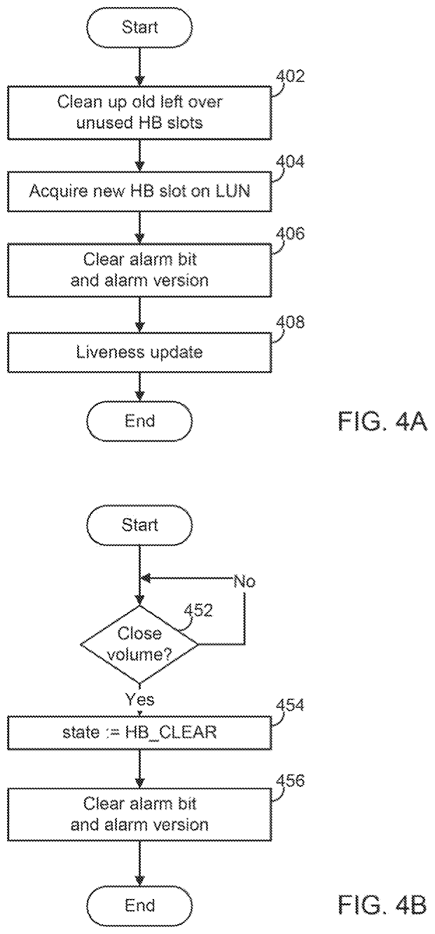

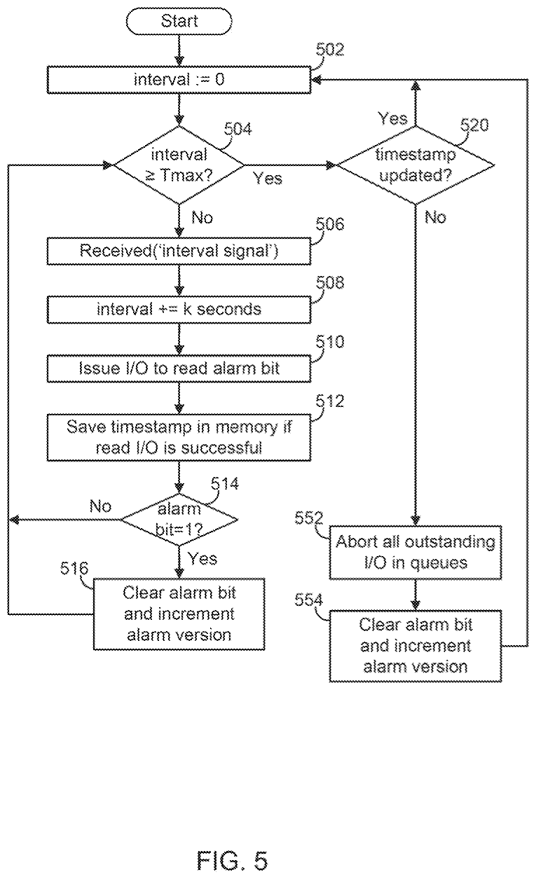

FIG. 4A depicts the flow of operations for host initialization, which is carried out by a file system driver of any host that is accessing the LUN for the first time. In step 402, the host cleans up any old, unused heartbeat slots. The cleaning up entails clearing HB slots if a host cannot find an empty slot for itself. Old (i.e., stale) slots are those that were generated in the case a host crashes or losses its connection and is thus not able to clear its HB slot (setting the state to HB_CLEAR) on its own. In step 404, the host acquires a new heartbeat slot from the available ones by writing an integer, HB_USED (e.g., 1), in data field 352 and writing its UUID in data field 360, and in step 406, the host clears the alarm version and the alarm bit (by writing 0) in the acquired heartbeat slot. Then, the host executes a process illustrated in FIG. 5 to update its liveness information as necessary.

FIG. 4B depicts the flow of operations that are carried out by a file system driver of any host to close its access to a LUN, in an embodiment. In step 452, the host determines whether or not its access to the LUN is to be closed. If so, the host in step 454 writes an integer, HB_CLEAR (e.g., 0), in data field 352. In step 456, the host clears the alarm version and the alarm bit.

FIG. 5 depicts the flow of operations that are carried out by a file system driver of a host (hereinafter referred to as the “owner host”) when step 408 of FIG. 4A is executed. The operations result in an update to the liveness information of the owner host, e.g., in situations where another host (hereinafter referred to as the “contending host”) has performed a liveness check on the owner host.

The owner host in step 502 initializes a time interval to zero, and in step 504 tests whether the time interval is greater than or equal to Tmax seconds (e.g., 12 seconds), which represents the amount of time the owner host is given to reclaim its heartbeat in situations where the owner host has not updated its liveness information because it was down or the network communication path between the owner host and the LUN was down. If the time interval is less than Tmax, the owner host in step 506 waits to be notified of the next time interval, which occurs every k seconds (e.g., 3 seconds). Upon being notified that the interval has elapsed, the owner host in step 508 increments the time interval by k. Then, in step 510, the owner host issues a read I/O to the LUN to read the alarm bit from its heartbeat slot. If the read I/O is successful, the owner host in step 512 saves a timestamp of the current time in memory (e.g., RAM 106 or 156) of the owner host. In step 514, the owner host checks whether the alarm bit is set. If the alarm bit is set (step 514; Yes), the owner host performs an ATS operation to clear the alarm bit and to increment the alarm version (step 516). After step 516, the flow returns to step 504. On the other hand, if the alarm bit is not set (step 514; No), no ATS operations are performed, and the flow continues to step 504.

Returning to step 504, if step 504, if the time interval is greater than or equal to Tmax, the owner host in step 520 checks to see if the timestamp stored in memory has been updated since the last time step 520 was carried out. If so, this means the read I/Os issued in step 510 were successful, and the network communication path between the owner host and the LUN is deemed to be operational. Then, the flow returns to step 502. On the other hand, if the timestamp stored in memory has not been updated since the last time step 520 was carried out, the owner host or the network communication path between the owner host and the LUN is deemed to have been down for a period of time, and the owner host executes steps 552 and 554.

In step 552, the host aborts all outstanding I/Os in the various I/O queues. Then, in step 554, the host performs an ATS operation to clear the alarm bit and to increment the alarm version to re-establish its heartbeat, i.e., to inform any contending host that the owner host is still alive. However, it should be recognized that if the network communication path between the owner host and the LUN is still down, the owner host will be unable to re-establish its heartbeat.

In contrast to conventional techniques for performing liveness updates (where an ATS operation is carried out during each timer interval), an ATS operation is carried out only as needed in the embodiments, i.e., when the alarm bit is set. As will be described below, the alarm bit is set by the contending host when the contending host is performing a liveness check on the owner host. In other words, when no other host has performed a liveness check on the owner host during the timer interval, the owner host merely issues a read I/O, and an ATS operation is not carried out.

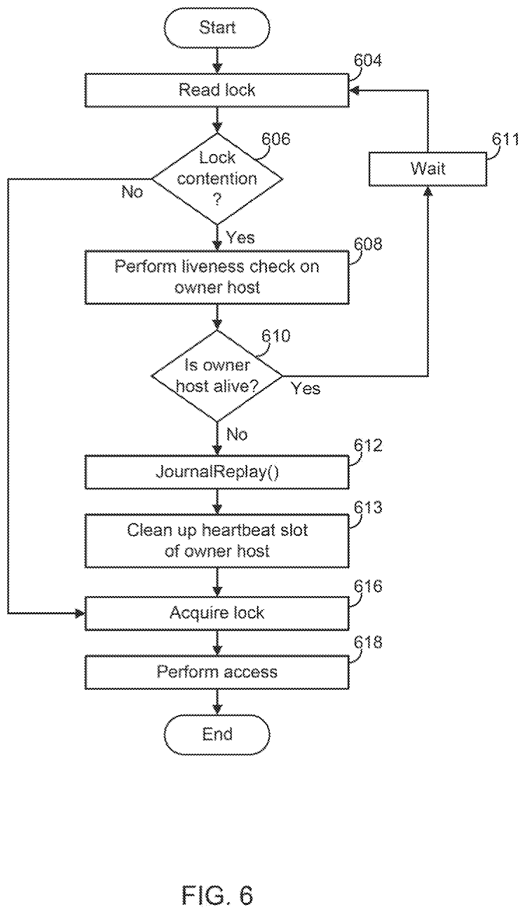

FIG. 6 depicts the flow of operations that are carried out by a file system driver of any host to acquire a lock on a file stored in the LUN. In step 604, the host reads the lock record to see if the lock is free. If the lock is not free, then the host checks the UUID of the host in the lock record. If the lock is free, there is no lock contention, the flow jumps to step 616, where the host acquires the lock by performing an ATS operation to write its UUID in data field 328 of the lock record. Then, the host accesses the file in step 618.

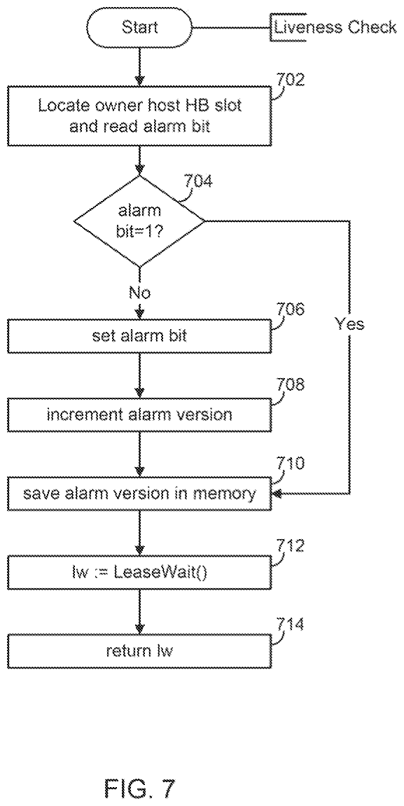

If there is lock contention (step 606; Yes, another host owns the lock), step 608 is executed where the host (hereinafter referred to as the “contending host”) performs a liveness check on the host that owns the lock (hereinafter referred to as the “owner host”). The liveness check is depicted in FIG. 7 and returns a state of the owner host, either alive or not alive.

If the state of the owner host is alive (step 610; Yes), the contending host waits for a period of time in step 611 before reading the lock record again in step 604. If the state of the owner host is not alive (step 610; No), the contending host executes steps 612 and 613 prior to acquiring the lock in step 616.

In step 612, the contending host executes a journal replay function by reading the journal address from the heartbeat slot of the owner host and replaying the journal of the owner host that is located at that journal address. In step 613, the contending host writes the integer HB_CLEAR in data field 352 of the owner host's heartbeat slot to indicate that the heartbeat slot is available for use and also clears the alarm bit and the alarm version in the owner host's heartbeat slot.

FIG. 7 depicts the flow of operations for the liveness check that is carried out by a file system driver of a contending host. In step 702, the contending host reads data field 334 of the lock record of the file that is in contention to locate the heartbeat slot of the owner host and reads the alarm bit and alarm version stored therein. If the alarm bit is not set (step 704; No), the contending host performs an ATS operation to set the alarm bit in step 706 and increment the alarm version in step 708. Then, in step 708, the contending host in step 710 saves the alarm version in memory. Returning to step 704, if the alarm bit is set (step 704; Yes), this means that a liveness check is already being performed on the owner host, and the flow skips to step 710, where the contending host saves the alarm version in memory.

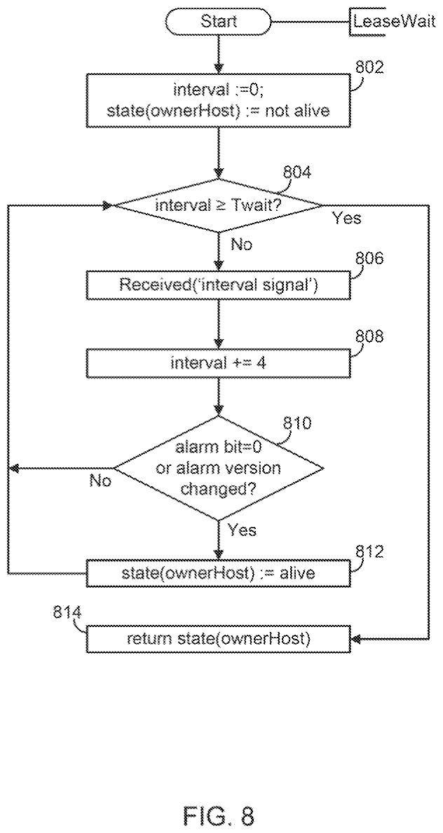

After step 710, the contending host executes a LeaseWait( ) function in step 712 to determine whether the owner host is alive or not alive. The flow of operations for the LeaseWait( ) function is depicted in FIG. 8. The liveness check returns in step 714 with the results of the LeaseWait( ) function.

In step 802, the contending host initializes a time interval to zero and the state of the owner host to be not alive. Then, in step 804 tests whether the time interval is greater than or equal to Twait seconds (e.g., 16 seconds), which represents the amount of time the contending host gives the owner host to establish its heartbeat before it determines the state of the owner host to be not alive. If the time interval is less than Twait, the contending host in step 806 waits to be notified of the next time interval, which occurs every k seconds (e.g., 4 seconds). Then, in step 810, the contending host reads the alarm bit and alarm version stored in the heartbeat slot of the owner host. If the alarm bit is 0, which means the owner host updated its heartbeat by clearing the alarm bit in step 516 or step 554, or the alarm version changed (i.e., different from the alarm version the contending host stored in memory in step 710), which means the owner host updated its heartbeat and a liveness check subsequent to the one that called this LeaseWait( ) function is being conducted on the host, the contending host in step 812 sets the state of the owner host to be alive. On the other hand, if the alarm bit is still 1 and the alarm version has not changed, the flow returns to step 804.

In the embodiments described above, an ATS operation to update a host's liveness information does not need to be executed during each timer interval. In place of the ATS operation, a read I/O is performed by the host during each timer interval to determine whether a liveness check is being performed thereon by another host, and the ATS operation is performed in response such a liveness check. Because a read I/O is in general 4-5 times faster than an ATS operation, embodiments reduce latencies in I/Os performed on files in a shared file system, and the improvement in latencies becomes even more significant as the number of hosts that are sharing the file system scale up to larger numbers, e.g., from 64 hosts to 1024 hosts.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers, each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained only to use a defined amount of resources such as CPU, memory, and I/O.

Certain embodiments may be implemented in a host computer without a hardware abstraction layer or an OS-less container. For example, certain embodiments may be implemented in a host computer running a Linux® or Windows® operating system.

The various embodiments described herein may be practiced with other computer system configurations, including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer-readable media. The term computer-readable medium refers to any data storage device that can store data which can thereafter be input to a computer system. Computer-readable media may be based on any existing or subsequently developed technology for embodying computer programs in a manner that enables them to be read by a computer. Examples of a computer-readable medium include a hard drive, network-attached storage (NAS), read-only memory, random-access memory (e.g., a flash memory device), a CD (Compact Discs)—CD-ROM, a CDR, or a CD-RW, a DVD (Digital Versatile Disc), a magnetic tape, and other optical and non-optical data storage devices. The computer-readable medium can also be distributed over a network-coupled computer system so that the computer-readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

1. A method of managing liveness information of a first server of a plurality of servers sharing a file system, the method comprising:
during each repeating time interval for updating the liveness information of the first server:
reading by the first server an alarm bit of the first server, from a region in the file system allocated for storing liveness information of the first server;
after each read by the first server, determining by the first server a value of the alarm bit; and
upon determining by the first server that the value of the alarm bit is a first value, changing the alarm bit to a second value, and writing the alarm bit having the second value in the region,
wherein the second value indicates to other servers of the plurality of servers that the first server is alive.

2. The method of claim 1, wherein a second server of the plurality of servers is configured to write the alarm bit having the first value to the region and then read the alarm bit from the region after a period of time greater than the time interval to determine if the first server is alive.

3. The method of claim 1, wherein the liveness information of the first server that is stored in the region includes an alarm version number which is changed each time the alarm bit is changed.

4. The method of claim 3, wherein a second server of the plurality of servers is configured to write the alarm bit having the first value and an updated alarm version number to the region, store the updated alarm version number in a memory region thereof, and then read the alarm bit and the alarm version number from the region after the period of time to determine if the first server is alive.

5. (canceled)

6. The method of claim 4, wherein the first server is determined to be alive if the alarm version number stored in the memory region thereof and the alarm version number read from the region after the period of time are different.

7. The method of claim 1, further comprising:
after each read by the first server, saving a timestamp of the current time if the read is successful; and
upon determining by the first server, that the timestamp has not changed after a period of time greater than the time interval, writing the alarm bit having the second value in the region.

8. The method of claim 1, wherein the alarm bit having the second value is written in the region using an atomic test and set operation, and the alarm bit is read from the region using a read I/O operation.

9. A computer system, comprising:
a storage device; and
a plurality of servers sharing a file system backed by the storage device, the servers including a first server and a second server,
wherein the first server is programmed to carry out a method of managing liveness information stored in a region in the file system, said method comprising:
during each repeating time interval for updating the liveness information of the first server:
reading an alarm bit of the first server from the region;
after each read, determining a value of the alarm bit; and
upon determining that the value of the alarm bit is a first value, changing the alarm bit to a second value, and writing the alarm bit having the second value in the region,
wherein the second value indicates to other servers of the plurality of servers that the first server is alive.

10. The computer system of claim 9, wherein the second server is configured to write the alarm bit having the first value to the region and then read the alarm bit from the region after a period of time greater than the time interval to determine if the first server is alive.

11. The computer system of claim 9, wherein the liveness information includes an alarm version number which is changed each time the alarm bit is changed.

12. The computer system of claim 11, wherein the second server is configured to write the alarm bit having the first value and an updated alarm version number to the region, store the updated alarm version number in a memory region thereof, and then read the alarm bit and the alarm version number from the region after the period of time to determine if the first server is alive.

13. (canceled)

14. The computer system of claim 12, wherein the first server is determined to be alive if the alarm version number stored in the memory region thereof and the alarm version number read from the region after the period of time are different.

15. The computer system of claim 9, wherein said method further comprises:
after each read, saving a timestamp of the current time if the read is successful; and
upon determining that the timestamp has not changed after a period of time greater than the time interval, writing the alarm bit having the second value in the region.

16. The computer system of claim 9, wherein the alarm bit having the second value is written in the region using an atomic test and set operation, and the alarm bit is read from the region using a read I/O operation.

17. A non-transitory computer-readable medium comprising instructions that are executable on a processor of a first server of a plurality of servers sharing a file system, wherein the instructions, when executed on the processor, cause the first server to carry out a method of managing liveness information of the first server, said method comprising:
during each repeating time interval for updating the liveness information of the first server:
reading an alarm bit of the first server, from a region in the file system allocated for storing liveness information of the first server;
after each read, determining a value of the alarm bit; and
upon determining that the value of the alarm bit is a first value, changing the alarm bit to a second value, and writing the alarm bit having the second value in the region,
wherein the second value indicates to other servers of the plurality of servers that the first server is alive.

18. The non-transitory computer-readable medium of claim 17, wherein a second server of the plurality of servers is configured to write the alarm bit having the first value to the region and then read the alarm bit from the region after a period of time greater than the time interval to determine if the first server is alive.

19. The non-transitory computer-readable medium of claim 17, wherein the liveness information of the first server that is stored in the region includes an alarm version number which is changed each time the alarm bit is changed.

20. The non-transitory computer-readable medium of claim 19, wherein a second server of the plurality of servers is configured to write the alarm bit having the first value and an updated alarm version number to the region, store the updated alarm version number in a memory region thereof, and then read the alarm bit and the alarm version number from the region after the period of time to determine if the first server is alive.

21. The non-transitory computer-readable medium of claim 20, wherein the first server is determined to be alive if the alarm version number stored in the memory region thereof and the alarm version number read from the region after the period of time are different.

22. The non-transitory computer-readable medium of claim 17, wherein the method further comprises:
after each read by the first server, saving a timestamp of the current time if the read is successful; and
upon determining by the first server, that the timestamp has not changed after a period of time greater than the time interval, writing the alarm bit having the second value in the region.
